(19) United States
(12) Patent Application Publication
(10) Pub. No.: US 2025/0053844 A1
(43) Pub. Date: Feb. 13, 2025

(54) System and method for load balancing using quantum computing

(71) Applicant: Bank of America Corporation, Charlotte, NC (US)

(72) Inventors: Swetapadma Mohanty, Hyderabad (IN); Prashant Kumar Mishra, Hyderabad (IN)

(21) Appl. No.: 18/447,914

(22) Filed: Aug. 10, 2023

(51) Int. Cl. G06N 10/60

(52) U.S. Cl. CPC G06N 10/60

(57) ABSTRACT

A method includes receiving parameters of each server of a plurality of servers. The parameters of each server are converted from classical to quantum bits. A final quantum state is determined based on a first converted parameter of each server. First intermediate weights of the servers are determined based on the final quantum state. (a) A subsequent final quantum state is determined based on current intermediate weights and a subsequent converted parameter of each server. (b) Subsequent intermediate weights of the servers are determined based on the subsequent final quantum state. Operations (a) and (b) are repeated until all converted parameters of each server are considered and final weights of the servers are determined. The final weights are converted from quantum to classical bits to determine converted weights. Statuses of the servers are determined based on the converted weights. The servers are grouped into server clusters based on the statuses.

### TECHNICAL FIELD

The present disclosure relates generally to load balancing, and more specifically to a system and method for load balancing using quantum computing.

### BACKGROUND

Due to the internet growth, servers are processing increasingly massive sets of requests. Current load balancing solutions are not efficient in dealing with increasing numbers of requests and servers, and are increasingly resource hungry.

### SUMMARY

The system described in the present disclosure provides several practical applications and technical advantages that overcome the current technical problems with load balancing.

In general, a system for load balancing using quantum computing includes a load balancing system operably coupled to a plurality of computing devices of users and a plurality of servers via a network. The load balancing system receives server parameters for each server of the plurality of servers. The load balancing system converts the server parameters for each server from classical bits to quantum bits. The load balancing system determines a first final quantum state based on a first converted server parameter of each server. The load balancing system determines a first error. In response to determining that the first error is less than an error threshold, the load balancing system determines first intermediate weights of the servers based on the first final quantum state. The load balancing system determines a subsequent final quantum state based on current weights of the servers and a subsequent converted server parameter of each server. The load balancing system determines a subsequent error. In response to determining that the subsequent error is less than the error threshold, the load balancing system determines subsequent intermediate weights of the servers based on the subsequent final quantum state. In response to determining that all converted server parameters of each server are considered, the load balancing system converts final weights of the servers from quantum bits to classical bits. The load balancing system determines statuses of the servers based on the converted weights. The load balancing system groups the servers into server clusters based on the determined statuses. The load balancing system receives a plurality of requests from the computing devices of the users. The load balancing system groups the plurality of requests into request groups. The load balancing system routes each of the request groups to a respective one of the server clusters. The load balancing system repeats the above operations until the load balancing system receives an instruction to terminate the load balancing process.

The system for load balancing using quantum computing allows for an efficient load balancing process by grouping servers into server clusters and requests into request groups, and routing each request group to a respective server cluster. By using a quantum processor implementing a quantum algorithm (e.g., quantum gradient boosting algorithm), speed of the load balancing process is increased due to quantum parallelism compared to classical algorithms executed by classical processors. Furthermore, by using quantum processors instead of classical processors, computing resources (e.g., memory, network bandwidth, etc.) that would be otherwise consumed by using the classical processors may be saved and used for other applications.

Accordingly, the following disclosure is particularly integrated into practical applications of: (1) improving efficiency of a load balancing process; (2) improving speed of the load balancing process by using quantum processors that implement quantum algorithms; and (3) improving utilization of computing resources by using quantum processors instead of classical processors.

In one embodiment, a system includes a load balancing system communicatively coupled to a plurality of servers and a plurality of user devices. The load balancing system includes a memory, and a classical processor and a quantum processor communicatively coupled to the memory. The memory is configured to store a quantum gradient boosting algorithm and an error threshold. The classical processor is configured to receive server parameters of each server of the plurality of servers, convert the server parameters of each server from classical bits to quantum bits, and send the converted server parameters of each server to the quantum processor. In response to sending the converted server parameters of each server to the quantum processor, the classical processor is further configured to receive converted weights of the plurality of servers from the quantum processor, determine statuses of the plurality of servers based on the converted weights, and group the plurality of servers into server clusters based on the statuses. The quantum processor implements the quantum gradient boosting algorithm. The quantum processor is configured to determine a first final quantum state based on a first converted server parameter of each server and determine a first error. In response to determining that the first error is less than the error threshold, the quantum processor is further configured to determine first intermediate weights of the plurality of servers based on the first final quantum state, (a) determine a subsequent final quantum state based on current intermediate weights and a subsequent converted server parameter of each server, (b) determine a subsequent error, and (c) in response to determining that the subsequent error is less than the error threshold, determine subsequent intermediate weights of the plurality of servers based on the subsequent final quantum state. The quantum processor is further configured repeat operations (a), (b), and (c) until all converted server parameters of each server are considered and final weights of the plurality of servers are determined and convert the final weights of the plurality of servers from quantum bits to classical bits to determine the converted weights.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 illustrates an embodiment of a system for load balancing using quantum computing; and

FIGS. 2A and 2B illustrate an example operational flow of system of FIG. 1 for load balancing using quantum computing.

### DETAILED DESCRIPTION

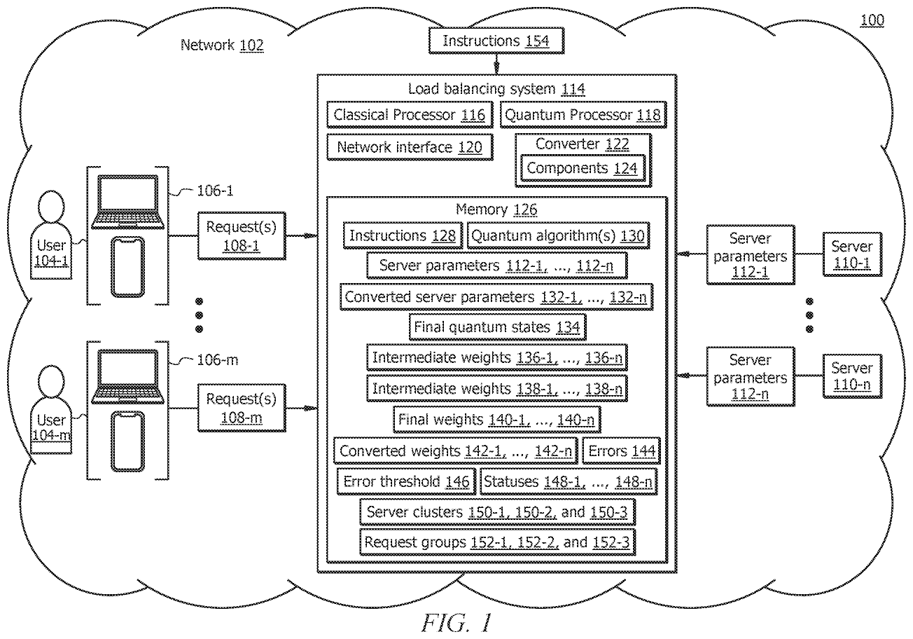

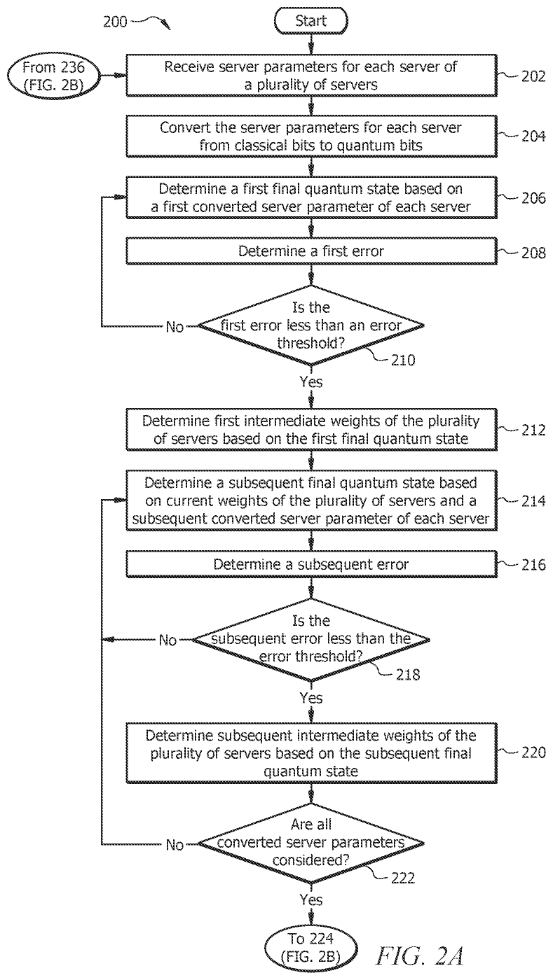

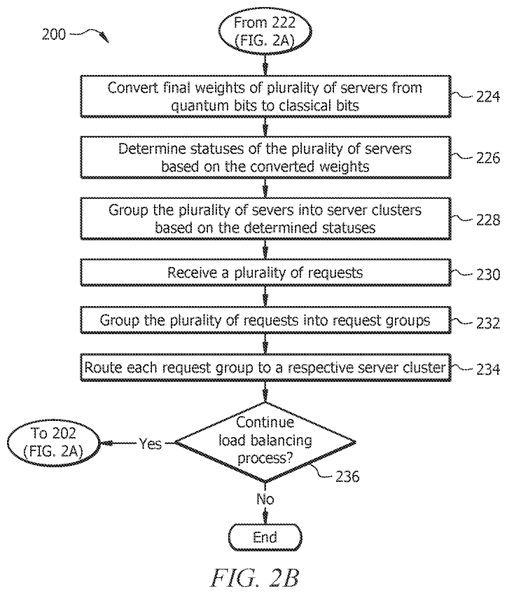

As described above, previous technologies fail to provide effective systems and methods for load balancing. Embodiments of the present disclosure and their advantages may be understood by referring to FIGS. 1, 2A and 2B. FIGS. 1, 2A and 2B are used to describe a system and method for load balancing using quantum computing.

### System Overview

FIG. 1 illustrates an embodiment of a system 100 for load balancing using. In certain embodiments, the system 100 comprises a load balancing system 114 operably coupled to a plurality of computing devices 106-1 through 106-m of users 104-1 through 104-m, respectively, and a plurality of servers 110-1 through 110-n via a network 102. Network 102 enables the communication between the components of the system 100. The plurality of servers 110-1 through 110-n are configured to provide various services to the users 104-1 through 104-m. In other embodiments, the system 100 may not have all the components listed and/or may have other elements instead of, or in addition to, those listed above.

In general, the load balancing system 114 receives server parameters (e.g., server parameters 112-1 through 112-n) for each server of the plurality of servers 110-1 through 110-n. The load balancing system 114 converts the server parameters (e.g., respective ones of server parameters 112-1 through 112-n) for each server (e.g., respective one of servers 110-1 through 110-n) from classical bits to quantum bits. The load balancing system 114 determines a first final quantum state (e.g., respective one of final quantum states 134) based on a first converted server parameter (e.g., respective one of converted server parameters 132-1 through 132-n) of each server (e.g., respective one of servers 110-1 through 110-n). The load balancing system 114 determines a first error (e.g., respective one of errors 144). In response to determining that the first error (e.g., respective one of errors 144) is less than the error threshold 146, the load balancing system 114 determines first intermediate weights (e.g., intermediate weights 136-1 through 136-n) of the servers 110-1 through 110-n based on the first final quantum state (e.g., respective one of final quantum states 134).

The load balancing system 114 determines a subsequent final quantum state (e.g., respective one of final quantum states 134) based on current weights (e.g., intermediate weights 136-1 through 136-n) of the servers 110-1 through 110-n and a subsequent converted server parameter (e.g., respective one of converted server parameters 132-1 through 132-n) of each server (e.g., respective one of servers 110-1 through 110-n). The load balancing system 114 determines a subsequent error (e.g., respective one of errors 144). In response to determining that the subsequent error (e.g., respective one of errors 144) is less than the error threshold 146, the load balancing system 114 determines subsequent intermediate weights (e.g., intermediate weights 138-1 through 138-n) of the servers 110-1 through 110-n based on the subsequent final quantum state (e.g., respective one of final quantum states 134).

In response to determining that all converted server parameters (e.g., respective ones of converted server parameters 132-1 through 132-n) of each server (e.g., respective one of servers 110-1 through 110-n) are considered, the load balancing system 114 converts final weights (e.g., final weights 140-1 through 140-n) of the servers 110-1 through 110-n from quantum bits to classical bits. The load balancing system 114 determines statuses 148-1 through 148-n of the servers 110-1 through 110-n based on the converted weights 142-1 through 142-n, respectively. The load balancing system 114 groups the servers 110-1 through 110-n into server clusters 150-1, 150-2, and 150-3 based on the determined statuses 148-1 through 148-n.

The load balancing system 114 receives a plurality of requests 108-1, . . . , and/or 108-m from the computing devices 106-1, . . . , and/or 106-m of the users 104-1, . . . , and/or 104-m, respectively. The load balancing system 114 groups the plurality of requests 108-1 through 108-m into request groups 152-1, 152-2, and 152-3. The load balancing system 114 routes each of the request groups 152-1, 152-2, and 152-3 to a respective one of the server clusters 150-1, 150-2, and 150-3. The load balancing system 114 repeats the above operations until the load balancing system 114 receives an instruction 154 to terminate the load balancing process.

### System Components

### Network

Network 102 may be any suitable type of wireless and/or wired network. The network 102 may or may not be connected to the Internet or public network. The network 102 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMax, etc.), a long-term evolution (LTE) network, a universal mobile telecommunications system (UMTS) network, a peer-to-peer (P2P) network, a Bluetooth network, a near field communication (NFC) network, and/or any other suitable network. The network 102 may be configured to support any suitable type of communication protocol as would be appreciated by one of ordinary skill in the art.

### Computing Devices

Each of computing devices 106-1 through 106-m is generally any device that is configured to process data and interact with a respective one of the user 104-1 through 104-m. Examples of the computing device include, but are not limited to, a personal computer, a desktop computer, a workstation, a server, a laptop, a tablet computer, a mobile phone (such as a smartphone), a virtual reality headset, etc. The computing device may include a user interface, such as a display, a microphone, keypad, or other appropriate terminal equipment usable by a respective user. Each of the computing devices 106-1 through 106-m may include a hardware processor, memory, and/or circuitry (not explicitly shown) configured to perform any of the functions or actions of the computing devices 106-1 through 106-m described herein. For example, software applications designed using software code may be stored in respective memories and executed by respective processors to perform the functions of the computing devices 106-1 through 106-m. The computing devices 106-1 through 106-m are configured to communicate with other components of the system 100 via the network 102. In operation, the computing devices 106-1 through 106-m of the users 104-1 through 104-m are configured send a plurality of requests 108-1 through 108-m to the load balancing system 114. The computing devices 106-1 through 106-m may be also referred to as user devices.

### Servers

Each of servers 110-1 through 110-n is generally any device that is configured to process data and interact with other components of the system 100. The plurality of servers 110-1 through 110-n are configured to provide various services to the users 104-1 through 104-m. Each of the servers 110-1 through 110-n may include a hardware processor, memory, and/or circuitry (not explicitly shown) configured to perform any of the functions or actions of the servers 110-1 through 110-n described herein. For example, software applications designed using software code may be stored in respective memories and executed by respective processors to perform the functions of the servers 110-1 through 110-n. The servers 110-1 through 110-n are configured to communicate with other components of the system 100 via the network 102. In operation, each of the servers 110-1 through 110-n are configured send a plurality of server parameters (e.g., respective one of server parameters 112-1 through 112-n) to the load balancing system 114. In certain embodiments, the plurality of server parameters (e.g., respective one of server parameters 112-1 through 112-n) may comprise server heartbeat, past connection statistics, past response statistics, resource availability, server utilization percentage, and server location.

### Load Balancing System

The load balancing system 114 is generally any device that is configured to process data and communicate with other components of the system 100 via the network 102. The load balancing system 114 may comprise a classical processor 116, a quantum processor 118, and a converter 122 in signal communication with a memory 126 and a network interface 120.

Classical processor 116 comprises one or more processors operably coupled to the memory 126. Classical processor 116 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). Classical processor 116 may be a programmable logic device, a microcontroller, a microprocessor, or any suitable combination of the preceding. The one or more processors are configured to process data and may be implemented in hardware or software. For example, classical processor 116 may be 8-bit, 16-bit, 32-bit, 64-bit, or of any other suitable architecture. The one or more processors are configured to implement various software instructions to perform the operations described herein. For example, the one or more processors are configured to execute software instructions 128 and perform one or more functions described herein.

Quantum processor 118 may comprise one or more quantum processors operably coupled to the memory 126. Quantum processor 118 is configured to process quantum bits. Quantum processor 118 may comprise a superconducting quantum device (with qubits implemented by states of Josephson junctions), a trapped ion device (with qubits implemented by internal states of trapped ions), a trapped neutral atom device (with qubits implemented by internal states of trapped neutral atoms), a photon-based device (with qubits implemented by modes of photons), or any other suitable device that implements quantum bits with states of a respective quantum system. Quantum processor 118 is configured to execute one or more quantum algorithms 130 to perform one or more functions described herein.

Converter 122 is configured to convert data items represented by classical binary bits to quantum bits. Converter 122 is further configured to convert data items represented by quantum bits to classical binary bits. In certain embodiments, the converter 122 comprises a plurality of components 124 that are configured to generate and manipulate quantum bits. In the illustrated embodiment, the plurality of components 124 and the quantum processor 118 are configured to operate on a same type of quantum bits. For example, when the quantum processor 118 comprises a photon-based device (with qubits implemented by modes of photons), the plurality of components 124 may comprise optical components such as lasers, mirrors, prisms, waveguides, interferometers, optical fibers, filters, polarizers, and/or lenses.

Network interface 120 is configured to enable wired and/or wireless communications (e.g., via network 102). Network interface 120 is configured to communicate data between the load balancing system 114 and other components of the system 100. For example, the network interface 120 may comprise a WIFI interface, a local area network (LAN) interface, a wide area network (WAN) interface, a modem, a switch, or a router. The classical processor 116 and the quantum processor 118 are configured to send and receive data using the network interface 120. Network interface 120 may be configured to use any suitable type of communication protocol as would be appreciated by one of ordinary skill in the art.

The memory 126 comprises a non-transitory computer-readable medium such as one or more disks, tape drives, or solid-state drives, and may be used as an over-flow data storage device, to store programs when such programs are selected for execution, and to store instructions and data that are read during program execution. Memory 126 may be volatile or non-volatile and may comprise a read-only memory (ROM), random-access memory (RAM), ternary content-addressable memory (TCAM), dynamic random-access memory (DRAM), and static random-access memory (SRAM). Memory 126 may be implemented using one or more disks, tape drives, solid-state drives, and/or the like. The memory 126 may store any of the information described in FIGS. 1, 2A and 2B along with any other data, instructions, logic, rules, or code operable to implement the function(s) described herein. The memory 126 is operable to store software instructions 128, the one or more quantum algorithms 130, and/or any other data and instructions. The software instructions 128 may comprise any suitable set of software instructions, logic, rules, or code operable to be executed by the classical processor 116. The one or more quantum algorithms 130 may comprise any suitable set of software instructions, logic, rules, or code operable to be executed by the quantum processor 118. In certain embodiments, the one or more quantum algorithms 130 may comprise a quantum gradient boosting algorithm.

In operation, the classical processor 116 of the load balancing system 114 receives server parameters (e.g., server parameters 112-1 through 112-n) for each server of the plurality of servers 110-1 through 110-n. In certain embodiments, the server parameters (e.g., respective ones of server parameters 112-1 through 112-n) of each server (e.g., respective one of servers 110-1 through 110-n) may comprise server heartbeat, past connection statistics, past response statistics, resource availability, server utilization percentage, and server location.

The classical processor 116 of the load balancing system 114 converts the server parameters (e.g., respective ones of server parameters 112-1 through 112-n) for each server (e.g., respective one of servers 110-1 through 110-n) from classical bits to quantum bits. In certain embodiments, the classical processor 116 of the load balancing system 114 instructs the converter 122 of the load balancing system 114 to convert the server parameters (e.g., respective ones of server parameters 112-1 through 112-n) for each server (e.g., respective one of servers 110-1 through 110-n) from classical bits to quantum bits and determine converted server parameters (e.g., respective ones of converted server parameters 132-1 through 132-n) for each server (e.g., respective one of servers 110-1 through 110-n).

The quantum processor 118 of the load balancing system 114 determines a first final quantum state (e.g., respective one of final quantum states 134) based on a first converted server parameter (e.g., respective one of converted server parameters 132-1 through 132-n) of each server (e.g., respective one of servers 110-1 through 110-n). The quantum processor 118 of the load balancing system 114 determines a first error (e.g., respective one of errors 144). In response to determining that the first error (e.g., respective one of errors 144) is less than the error threshold 146, the quantum processor 118 of the load balancing system 114 determines first intermediate weights (e.g., intermediate weights 136-1 through 136-n) of the servers 110-1 through 110-n based on the first final quantum state (e.g., respective one of final quantum states 134).

The quantum processor 118 of the load balancing system 114 determines a subsequent final quantum state (e.g., respective one of final quantum states 134) based on current weights (e.g., intermediate weights 136-1 through 136-n) of the servers 110-1 through 110-n and a subsequent converted server parameter (e.g., respective one of converted server parameters 132-1 through 132-n) of each server (e.g., respective one of servers 110-1 through 110-n). The quantum processor 118 of the load balancing system 114 determines a subsequent error (e.g., respective one of errors 144). In response to determining that the subsequent error (e.g., respective one of errors 144) is less than the error threshold 146, the quantum processor 118 of the load balancing system 114 determines subsequent intermediate weights (e.g., intermediate weights 138-1 through 138-n) of the servers 110-1 through 110-n based on the subsequent final quantum state (e.g., respective one of final quantum states 134).

In response to determining that all converted server parameters (e.g., respective ones of converted server parameters 132-1 through 132-n) of each server (e.g., respective one of servers 110-1 through 110-n) are considered, the quantum processor 118 of the load balancing system 114 converts final weights (e.g., final weights 140-1 through 140-n) of the servers 110-1 through 110-n from quantum bits to classical bits. In certain embodiments, the quantum processor 118 of the load balancing system 114 instructs the converter 122 of the load balancing system 114 to convert the final weights (e.g., final weights 140-1 through 140-n) of the servers 110-1 through 110-n from quantum bits to classical bits and determine converted weights 142-1 through 142-n of the servers 110-1 through 110-n. The converted weights 142-1 through 142-n determine probabilities of respective servers 110-1 through 110-n being healthy. In certain embodiments, each of the converted weights 142-1 through 142-n is in a range from 0 to 1, which corresponds to a probability in a range from 0% to 100%. In certain embodiments, the quantum processor 118 of the load balancing system 114 implements one or more quantum algorithms 130 such as a quantum gradient boosting algorithm.

The classical processor 116 of the load balancing system 114 determines statuses 148-1 through 148-n of the servers 110-1 through 110-n based on the converted weights 142-1 through 142-n, respectively. Each of the statuses 148-1 through 148-n may be “healthy,” “intermediate,” or “vulnerable.” In certain embodiments when a converted weight (e.g., respective one of converted weights 142-1 through 142-n) is in a range from 0.7 to 1, a respective status (e.g., respective one of statuses 148-1 through 148-n) is determined as “healthy.” In certain embodiments when a converted weight (e.g., respective one of converted weights 142-1 through 142-n) is in a range from 0.3 to 0.7, a respective status (e.g., respective one of statuses 148-1 through 148-n) is determined as “intermediate.” In certain embodiments when a converted weight (e.g., respective one of converted weights 142-1 through 142-n) is in a range from 0 to 0.3, a respective status (e.g., respective one of statuses 148-1 through 148-n) is determined as “vulnerable.”

The classical processor 116 of the load balancing system 114 groups the servers 110-1 through 110-n into server clusters 150-1, 150-2, and 150-3 based on the determined statuses 148-1 through 148-n. The server cluster 150-1 comprises a first subset of the servers 110-1 through 110-n, statuses of which are determined as “healthy.” The server cluster 150-2 comprises a second subset of the servers 110-1 through 110-n, statuses of which are determined as “intermediate.” The server cluster 150-3 comprises a third subset of the servers 110-1 through 110-n, statuses of which are determined as “vulnerable.”

The classical processor 116 of the load balancing system 114 receives a plurality of requests 108-1, . . . , and/or 108-m from the users 104-1, . . . , and/or 104-m, respectively. In certain embodiments, the classical processor 116 of the load balancing system 114 receives the plurality of requests 108-1, . . . , and/or 108-m from the computing devices 106-1, . . . , and/or 106-m of the users 104-1, . . . , and/or 104-m, respectively.

The classical processor 116 of the load balancing system 114 groups the plurality of requests 108-1 through 108-m into request groups 152-1, 152-2, and 152-3. In certain embodiments, the classical processor 116 of the load balancing system 114 may group the plurality of requests 108-1 through 108-m into the request groups 152-1, 152-2, and 152-3 based on priority. For example, the request group 152-1 may comprise a first subset of the requests 108-1 through 108-m that have “high” priority, the request group 152-2 may comprise a second subset of the requests 108-1 through 108-m that have “intermediate” priority, and the request group 152-3 may comprise a third subset of the requests 108-1 through 108-m that have “low” priority.

The classical processor 116 of the load balancing system 114 routes each of the request groups 152-1, 152-2, and 152-3 to a respective one of the server clusters 150-1, 150-2, and 150-3. In certain embodiments, the request group 152-1 is routed to the server cluster 150-1, the request group 152-2 is routed to the server cluster 150-2, and the request group 152-3 is routed to the server cluster 150-3. The load balancing system 114 repeats the above operations until the classical processor 116 of the load balancing system 114 receives an instruction 154 to terminate the load balancing process.

### Example Method for Load Balancing Using Quantum Computing

FIGS. 2A and 2B illustrate an example flowchart of a method 200 for load balancing using quantum computing. Modifications, additions, or omissions may be made to method 200. Method 200 may include more, fewer, or other operations. For example, operations may be performed in parallel or in any suitable order. For example, one or more operations of method 200 may be implemented, at least in part, in the form of the software instructions (e.g., instructions 128 and/or one or more quantum algorithms 130 of FIG. 1), stored on non-transitory, tangible, computer-readable medium (e.g., memory 126 of FIG. 1) that when executed by one or more processors (e.g., processors 116 and/or 118 of FIG. 1) may cause the one or more processors to perform operations 202-236.

Method 200 starts with operation 202, where a classical processor 116 of a load balancing system 114 receives server parameters (e.g., server parameters 112-1 through 112-n of FIG. 1) for each server of a plurality of servers 110-1 through 110-n. In certain embodiments, the server parameters (e.g., respective ones of server parameters 112-1 through 112-n of FIG. 1) of each server (e.g., respective one of servers 110-1 through 110-n of FIG. 1) may comprise server heartbeat, past connection statistics, past response statistics, resource availability, server utilization percentage, and server location.

At operation 204, the classical processor 116 of the load balancing system 114 converts the server parameters (e.g., respective ones of server parameters 112-1 through 112-n of FIG. 1) for each server (e.g., respective one of servers 110-1 through 110-n of FIG. 1) from classical bits to quantum bits. In certain embodiments, the classical processor 116 of the load balancing system 114 instructs a converter 122 of the load balancing system 114 to convert the server parameters (e.g., respective ones of server parameters 112-1 through 112-n of FIG. 1) for each server (e.g., respective one of servers 110-1 through 110-n of FIG. 1) from classical bits to quantum bits and determine converted server parameters (e.g., respective ones of converted server parameters 132-1 through 132-n of FIG. 1) for each server (e.g., respective one of servers 110-1 through 110-n of FIG. 1). The classical processor 116 of the load balancing system 114 sends the converted server parameters (e.g., respective ones of converted server parameters 132-1 through 132-n of FIG. 1) for each server (e.g., respective one of servers 110-1 through 110-n of FIG. 1) to a quantum processor 118 of the load balancing system 114.

At operation 206, the quantum processor 118 of the load balancing system 114 determines a first final quantum state (e.g., respective one of final quantum states 134 of FIG. 1) based on a first converted server parameter (e.g., respective one of converted server parameters 132-1 through 132-n of FIG. 1) of each server (e.g., respective one of servers 110-1 through 110-n of FIG. 1).

At operation 208, the quantum processor 118 of the load balancing system 114 determines a first error (e.g., respective one of errors 144 of FIG. 1).

At operation 210, the quantum processor 118 of the load balancing system 114 determines if the first error (e.g., respective one of errors 144 of FIG. 1) is less than an error threshold 146.

In response to determining at operation 210 that the first error (e.g., respective one of errors 144 of FIG. 1) is not less than the error threshold 146, method 200 goes back to operation 206. In certain embodiments, method 200 repeats operations 206 through 210 one or more times until the first error (e.g., respective one of errors 144 of FIG. 1) is less than the error threshold 146.

In response to determining at operation 210 that the first error (e.g., respective one of errors 144 of FIG. 1) is less than the error threshold 146, method 200 continues to operation 212. At operation 212, the quantum processor 118 of the load balancing system 114 determines first intermediate weights (e.g., intermediate weights 136-1 through 136-n of FIG. 1) of the servers 110-1 through 110-n based on the first final quantum state (e.g., respective one of final quantum states 134 of FIG. 1).

At operation 214, the quantum processor 118 of the load balancing system 114 determines a subsequent final quantum state (e.g., respective one of final quantum states 134 of FIG. 1) based on current weights (e.g., intermediate weights 136-1 through 136-n of FIG. 1) of the servers 110-1 through 110-n and a subsequent converted server parameter (e.g., respective one of converted server parameters 132-1 through 132-n of FIG. 1) of each server (e.g., respective one of servers 110-1 through 110-n of FIG. 1).

At operation 216, the quantum processor 118 of the load balancing system 114 determines a subsequent error (e.g., respective one of errors 144 of FIG. 1).

At operation 218, the quantum processor 118 of the load balancing system 114 determines if the subsequent error (e.g., respective one of errors 144 of FIG. 1) is less than the error threshold 146.

In response to determining at operation 218 that the subsequent error (e.g., respective one of errors 144 of FIG. 1) is not less than the error threshold 146, method 200 goes back to operation 214. In certain embodiments, method 200 repeats operations 214 through 218 one or more times until the subsequent error (e.g., respective one of errors 144 of FIG. 1) is less than the error threshold 146.

In response to determining at operation 218 that the subsequent error (e.g., respective one of errors 144 of FIG. 1) is less than the error threshold 146, method 200 continues to operation 220. At operation 220, the quantum processor 118 of the load balancing system 114 determines subsequent intermediate weights (e.g., intermediate weights 138-1 through 138-n of FIG. 1) of the servers 110-1 through 110-n based on the subsequent final quantum state (e.g., respective one of final quantum states 134 of FIG. 1).

At operation 222, the quantum processor 118 of the load balancing system 114 determines if all converted server parameters (e.g., respective ones of converted server parameters 132-1 through 132-n of FIG. 1) of each server (e.g., respective one of servers 110-1 through 110-n of FIG. 1) are considered.

In response to determining at operation 222 that all converted server parameters (e.g., respective ones of converted server parameters 132-1 through 132-n of FIG. 1) of each server (e.g., respective one of servers 110-1 through 110-n of FIG. 1) are not considered, method 200 goes back to operation 214. In certain embodiments, method 200 repeats operations 214 through 222 one or more times until that all converted server parameters (e.g., respective ones of converted server parameters 132-1 through 132-n of FIG. 1) of each server (e.g., respective one of servers 110-1 through 110-n of FIG. 1) are considered.

In response to determining at operation 222 that all converted server parameters (e.g., respective ones of converted server parameters 132-1 through 132-n of FIG. 1) of each server (e.g., respective one of servers 110-1 through 110-n of FIG. 1) are considered, method 200 continues to operation 224. At operation 224, the quantum processor 118 of the load balancing system 114 converts final weights (e.g., final weights 140-1 through 140-n of FIG. 1) of the servers 110-1 through 110-n from quantum bits to classical bits. In certain embodiments, the quantum processor 118 of the load balancing system 114 instructs the converter 122 of the load balancing system 114 to convert the final weights (e.g., final weights 140-1 through 140-n of FIG. 1) of the servers 110-1 through 110-n from quantum bits to classical bits and determine converted weights 142-1 through 142-n of the servers 110-1 through 110-n. The converted weights 142-1 through 142-n determine probabilities of respective servers 110-1 through 110-n being healthy. In certain embodiments, each of the converted weights 142-1 through 142-n is in a range from 0 to 1, which corresponds to a probability in a range from 0% to 100%.

In certain embodiments, the quantum processor 118 of the load balancing system 114 implements one or more quantum algorithms 130 such as a quantum gradient boosting algorithm while performing operations 206 through 224 of method 200. The quantum processor 118 of the load balancing system 114 sends the converted weights 142-1 through 142-n of the servers 110-1 through 110-n to the classical processor 116 of the load balancing system 114.

At operation 226, the classical processor 116 of the load balancing system 114 determines statuses 148-1 through 148-n of the servers 110-1 through 110-n based on the converted weights 142-1 through 142-n, respectively. Each of the statuses 148-1 through 148-n may be “healthy,” “intermediate.” or “vulnerable.” In certain embodiments when a converted weight (e.g., respective one of converted weights 142-1 through 142-n of FIG. 1) is in a range from 0.7 to 1, a respective status (e.g., respective one of statuses 148-1 through 148-n of FIG. 1) is determined as “healthy.” In certain embodiments when a converted weight (e.g., respective one of converted weights 142-1 through 142-n of FIG. 1) is in a range from 0.3 to 0.7, a respective status (e.g., respective one of statuses 148-1 through 148-n of FIG. 1) is determined as “intermediate.” In certain embodiments when a converted weight (e.g., respective one of converted weights 142-1 through 142-n of FIG. 1) is in a range from 0 to 0.3, a respective status (e.g., respective one of statuses 148-1 through 148-n of FIG. 1) is determined as “vulnerable.”

At operation 228, the classical processor 116 of the load balancing system 114 groups the servers 110-1 through 110-n into server clusters 150-1, 150-2, and 150-3 based on the determined statuses 148-1 through 148-n. The server cluster 150-1 comprises a first subset of the servers 110-1 through 110-n, statuses of which are determined as “healthy.” The server cluster 150-2 comprises a second subset of the servers 110-1 through 110-n, statuses of which are determined as “intermediate.” The server cluster 150-3 comprises a third subset of the servers 110-1 through 110-n, statuses of which are determined as “vulnerable.”

At operation 230, the classical processor 116 of the load balancing system 114 receives a plurality of requests 108-1, . . . , and/or 108-m from the users 104-1 . . . , and/or 104-m, respectively. In certain embodiments, the classical processor 116 of the load balancing system 114 receives the plurality of requests 108-1, . . . , and/or 108-m from the computing devices 106-1, . . . , and/or 106-m of the users 104-1, . . . , and/or 104-m, respectively.

At operation 232, the classical processor 116 of the load balancing system 114 groups the plurality of requests 108-1 through 108-m into request groups 152-1, 152-2, and 152-3. In certain embodiments, the classical processor 116 of the load balancing system 114 may group the plurality of requests 108-1 through 108-m into the request groups 152-1, 152-2, and 152-3 based on priority. For example, the request group 152-1 may comprise a first subset of the requests 108-1 through 108-m that have “high” priority, the request group 152-2 may comprise a second subset of the requests 108-1 through 108-m that have “intermediate” priority, and the request group 152-3 may comprise a third subset of the requests 108-1 through 108-m that have “low” priority.

At operation 234, the classical processor 116 of the load balancing system 114 routes each of the request groups 152-1, 152-2, and 152-3 to a respective one of the server clusters 150-1, 150-2, and 150-3. In certain embodiments, the request group 152-1 is routed to the server cluster 150-1, the request group 152-2 is routed to the server cluster 150-2, and the request group 152-3 is routed to the server cluster 150-3.

At operation 236, the classical processor 116 of the load balancing system 114 determines if an instruction 154 to terminate a load balancing process is received. In response to determining at operation 236 that the instruction 154 to terminate the load balancing process is not received, method 200 goes back to operation 202. In certain embodiments, method 200 repeats operations 202 through 236 one or more times until the instruction 154 to terminate the load balancing process is received. In response to determining at operation 236 that the instruction 154 to terminate the load balancing process is received, method 200 ends.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a load balancing system communicatively coupled to a plurality of servers and a plurality of user devices, wherein the load balancing system comprises:
a memory configured to store:
a quantum gradient boosting algorithm; and
an error threshold;
a classical processor communicatively coupled to the memory, wherein the classical processor is configured to:
receive server parameters of each server of the plurality of servers;
convert the server parameters of each server from classical bits to quantum bits;
send the converted server parameters of each server to a quantum processor;
in response to sending the converted server parameters of each server to a quantum processor, receive converted weights of the plurality of servers from the quantum processor;
determine statuses of the plurality of servers based on the converted weights; and
group the plurality of servers into server clusters based on the statuses; and
the quantum processor communicatively coupled to the memory, the quantum processor implementing the quantum gradient boosting algorithm, wherein the quantum processor is configured to:
determine a first final quantum state based on a first converted server parameter of each server;
determine a first error;
in response to determining that the first error is less than the error threshold:
determine first intermediate weights of the plurality of servers based on the first final quantum state;
(a) determine a subsequent final quantum state based on current intermediate weights and a subsequent converted server parameter of each server;
(b) determine a subsequent error; and
(c) in response to determining that the subsequent error is less than the error threshold, determine subsequent intermediate weights of the plurality of servers based on the subsequent final quantum state;
repeat operations (a), (b), and (c) until all converted server parameters of each server are considered and final weights of the plurality of servers are determined; and
convert the final weights of the plurality of servers from quantum bits to classical bits to determine the converted weights.

2. The system of claim 1, wherein the classical processor is further configured to:
receive a plurality of requests from the plurality of user devices;
group the plurality of requests into request groups; and
route each request group to a respective server cluster.

3. The system of claim 1, wherein the server parameters of each server comprise server heartbeat, past connection statistics, past response statistics, resource availability, server utilization percentage, and server location.

4. The system of claim 1, wherein each of the converted weights determines a probability of a respective server being healthy.

5. The system of claim 1, wherein each of the statuses is healthy, intermediate, or vulnerable.

6. The system of claim 1, wherein:
the load balancing system further comprises a converter communicatively coupled to the quantum processor and the classical processor; and
the quantum processor is further configured to instruct a converter to convert the final weights of the plurality of servers from quantum bits to classical bits.

7. The system of claim 6, wherein the classical processor is further configured to instruct the converter to convert the server parameters of each server from classical bits to quantum bits.

8. A method comprising:
receiving server parameters of each server of a plurality of servers;
converting the server parameters of each server from classical bits to quantum bits;
determining a first final quantum state based on a first converted server parameter of each server;
determining a first error;
in response to determining that the first error is less than an error threshold:
determining first intermediate weights of the plurality of servers based on the first final quantum state;
(a) determining a subsequent final quantum state based on current intermediate weights and a subsequent converted server parameter of each server;
(b) determining a subsequent error; and
(c) in response to determining that the subsequent error is less than the error threshold, determining subsequent intermediate weights of the plurality of servers based on the subsequent final quantum state;
repeating operations (a), (b), and (c) until all converted server parameters of each server are considered and final weights of the plurality of servers are determined;
converting the final weights of the plurality of servers from quantum bits to classical bits to determine converted weights;
determining statuses of the plurality of servers based on the converted weights; and
grouping the plurality of servers into server clusters based on the statuses.

9. The method of claim 8, further comprising:
receiving a plurality of requests from a plurality of user devices;
grouping the plurality of requests into request groups; and
routing each request group to a respective server cluster.

10. The method of claim 9, wherein the plurality of requests is grouped into the request groups based on priority.

11. The method of claim 8, wherein the server parameters of each server comprise server heartbeat, past connection statistics, past response statistics, resource availability, server utilization percentage, and server location.

12. The method of claim 8, wherein each of the converted weights determines a probability of a respective server being healthy.

13. The method of claim 8, wherein each of the statuses is healthy, intermediate, or vulnerable.

14. The method of claim 8, wherein determining the first final quantum state comprises implementing a quantum gradient boosting algorithm.

15. A non-transitory computer-readable medium storing instructions that, when executed by at least one classical processor and at least one quantum processor, cause the at least one classical processor and the at least one quantum processor to:
receive server parameters of each server of a plurality of servers;
convert the server parameters of each server from classical bits to quantum bits;
determine a first final quantum state based on a first converted server parameter of each server;
determine a first error;
in response to determining that the first error is less than an error threshold:
determine first intermediate weights of the plurality of servers based on the first final quantum state;
(a) determine a subsequent final quantum state based on current intermediate weights and a subsequent converted server parameter of each server;
(b) determine a subsequent error; and
(c) in response to determining that the subsequent error is less than the error threshold, determine subsequent intermediate weights of the plurality of servers based on the subsequent final quantum state;
repeat operations (a), (b), and (c) until all converted server parameters of each server are considered and final weights of the plurality of servers are determined;
convert the final weights of the plurality of servers from quantum bits to classical bits to determine converted weights;
determine statuses of the plurality of servers based on the converted weights; and
group the plurality of servers into server clusters based on the statuses.

16. The non-transitory computer-readable medium of claim 15, wherein the instructions, when executed by the at least one classical processor and the at least one quantum processor, further cause the at least one classical processor and the at least one quantum processor to:
receive a plurality of requests from a plurality of user devices;
group the plurality of requests into request groups; and
route each request group to a respective server cluster.

17. The non-transitory computer-readable medium of claim 16, wherein the plurality of requests is grouped into the request groups based on priority.

18. The non-transitory computer-readable medium of claim 15, wherein the server parameters of each server comprise server heartbeat, past connection statistics, past response statistics, resource availability, server utilization percentage, and server location.

19. The non-transitory computer-readable medium of claim 15, wherein each of the converted weights determines a probability of a respective server being healthy.

20. The non-transitory computer-readable medium of claim 15, wherein each of the statuses is healthy, intermediate, or vulnerable.
